(19) United States
(12) Patent Application Publication
(10) Pub. No.: US 2014/0191574 A1
(43) Pub. Date: Jul. 10, 2014

(54) VIRTUAL PARALLEL LOAD BANK SYSTEM

(71) Applicant: EXPERIUM TECHNOLOGIES, LLC, Owings, MD (US)

(72) Inventor: Lance Palatini, Morris Plains, NJ (US)

(73) Assignee: EXPERIUM TECHNOLOGIES, LLC, Owings, MD (US)

(21) Appl. No.: 13/737,262

(22) Filed: Jan. 9, 2013

(51) Int. Cl. H02J 4/00

(52) U.S. Cl. CPC H02J 4/00
USPC 307/38

(57) ABSTRACT

A virtual parallel load bank system is characterized by a load band connected in parallel with the source terminals of a voltage source to create a specific current to be applied to the terminals. The load bank includes a plurality of loads that are selectively connected in accordance with the desired current for the voltage source. One load device is designated as a master load and a communication network is connected with the load devices to enable the master load device to communicate with the other load devices to determine which are available for connection in the virtual load bank system.

### BACKGROUND OF THE INVENTION

A load bank is an electronically activated system that creates an electrical current load on a voltage source by using the current control capacity of a field effect transistor or fixed resistive, capacitive or inductive elements switched across the voltage source. The present invention relates to a virtual parallel load bank system in which a plurality of loads can be automatically or selectively connected across a voltage source to control the current supplied to the source.

### BRIEF DESCRIPTION OF THE PRIOR ART

Load banks are well known in the patented prior art as evidenced by the Fong U.S. Pat. No. 7,683,553 which discloses a current control circuit in which matching drive currents through a plurality of parallel loads are set. A regulated voltage is provided to one terminal of a capacitor and to one terminal of each load and provides a source of current for the loads. The Tanner U.S. Pat. No. 7,479,713 discloses a fixed output linear voltage regulator used to drive a plurality of loads connected in parallel to control power dissipation.

While the prior devices operate satisfactorily, they lack versatility in that they are not capable of providing a specific high level of current to a voltage source, such as is necessary for testing the source. The present invention was developed in order to overcome these and other drawbacks of the prior art by providing a virtual load bank system in which loads are able to communicate with each other and available loads can be combined to define a load bank which provides a precise current to a voltage source.

### SUMMARY OF THE INVENTION

Accordingly, it is a primary objection of the invention to provide a load system for creating a current to be applied to the terminals of a voltage source. The system includes a load bank connected in parallel with the source terminals. The load bank includes a plurality of loads which can be field effect transistors or fixed inductive, capacitive or resistive elements. Where the load is a fixed element such as an inductor, a relay is connected in series with the element to enable the element to be selectively connected with the source terminals based on the condition of the relay. A controller is connected with the load bank to select at least one load for connection with the source terminals. In addition, a communication network is connected with the loads for communicating status and command information therebetween.

The communication network includes a wired or wireless network and the load bank includes a plurality of loads of different capacities in different locations. The load bank system is created by linking selected loads via the communication network to precisely create and control the current supplied to the source terminals. A computer is preferably connected with the communication network and the controller to automatically create a load system combination which provides a selected load current to the source terminals in accordance with the properties of the voltage source. A manual controller is also connected with the controller to manually select the combination of loads connected with the source terminals.

According to another embodiment of the invention, a method for creating a virtual load bank to supply a current to the terminals of a voltage source is provided. In accordance with the method, a load bank is connected in parallel with the source terminals. One of the loads of the load bank is designated as a master load for connection with the terminals. The master load sends an inquiry to other loads in the load bank via a communication network to determine the availability of the other loads for connection with the source terminals. From among the available loads, a least one other load is connected in parallel with the master load and the source terminals to precisely create and control the current supplied to the source terminals in accordance with the loads.

Each load is provided with a network address, and the addresses of available loads are stored in a memory. The addresses can be used to manually select available loads for connection with the source terminals. In addition, for each load that responds to an inquiry, the master load updates variables for total system power, total system current, and total number of available loads in the memory. This information is used to either automatically or manually select specific loads for connection a virtual load bank for connection with the source terminals to create a specific virtual load current fort the power source.

### BRIEF DESCRIPTION OF THE FIGURES

Other objects and advantages of the invention will become apparent from a study of the following specification when viewed in the light of the accompanying drawing, in which:

FIG. 1 is a schematic representation of a field effect transistor used as a load device for a voltage source;

FIG. 2 is a schematic representation of a fixed inductor or resistor used as a load device for a voltage source;

FIG. 3 is block diagram of a load system for generating high currents for a voltage source according to the invention;

FIG. 4 is a schematic diagram of a plurality of load systems connected in parallel with a voltage source;

FIG. 5 is a schematic diagram of a plurality of load systems connected in parallel with a communication link between the load systems;

FIG. 6 is a schematic diagram showing an improved communication network for a plurality of load systems connected in parallel according to the invention;

FIG. 7 is a flow diagram illustrating the method for creating a virtual load bank according to the invention;

FIG. 8 is a flow diagram illustrating start-up of the virtual load bank system according to the invention;

FIG. 9 is a flow diagram of the communication of commands within the virtual load bank system according to the invention; and

FIG. 10 is a flow diagram of a master load command operation according to the invention.

### DETAILED DESCRIPTION

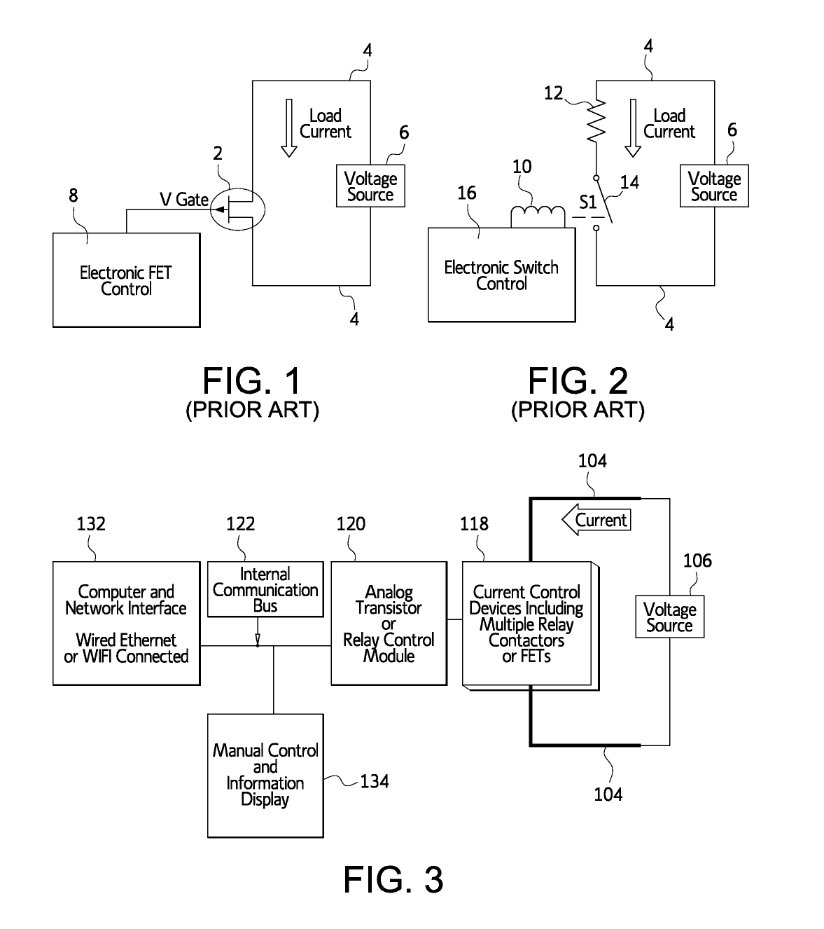

FIGS. 1 and 2 show load systems according to the prior art. In FIG. 1 there is shown a field effect transistor (FET) 2 connected across the terminals 4 of a voltage source 6. The transistor is an electric device where the current through the device is controlled by the voltage applied to a specific terminal. In FIG. 1, the load current through two terminals of the transistor 2 is proportional to the voltage applied to the gate terminal. This voltage is the gate voltage V_{gate} which is provided from an electronic control device 8 for the field effect transistor.

In FIG. 2, a fixed inductor 10 or a fixed resistor 12 is connected across the terminals 4 of the voltage source 6. A relay 14 is connected in series with the inductor and resistor. It is readily understood by those of ordinary skill in the art that a capacitive device may be used as well. An electronic switch controller 16 operates the relay to determine whether the inductor or resistor or both are connected with the source terminals for supplying the load current.

The load system according to the invention uses the relationships between the field effect transistor or the fixed inductive, resistive or capacitive devices to create high currents that can be controlled in a very precise manner.

Referring to FIG. 3, the load system according to an embodiment of the invention will be described. The load system is used to generate a controlled current across the terminals 104 of a voltage source 106. A load bank 118 is connected in parallel with the source terminals 4. As will be developed below, the load bank includes a plurality of current control devices or loads which are selectively connected with the source terminals. The loads can be of the field effect transistor type as shown in FIG. 1 or of the inductive, resistive or capacitive type, each including a series connected relay, as shown in FIG. 2. A controller 120 is connected with the load bank for selecting at least one load for connection with the source terminals. The controller is in the form of an analog transistor module or a relay control module, depending on the type of load being used. A communication network 122 is connected with the loads for communicating status and command information between the loads. The communication network is either a wired or wireless network.

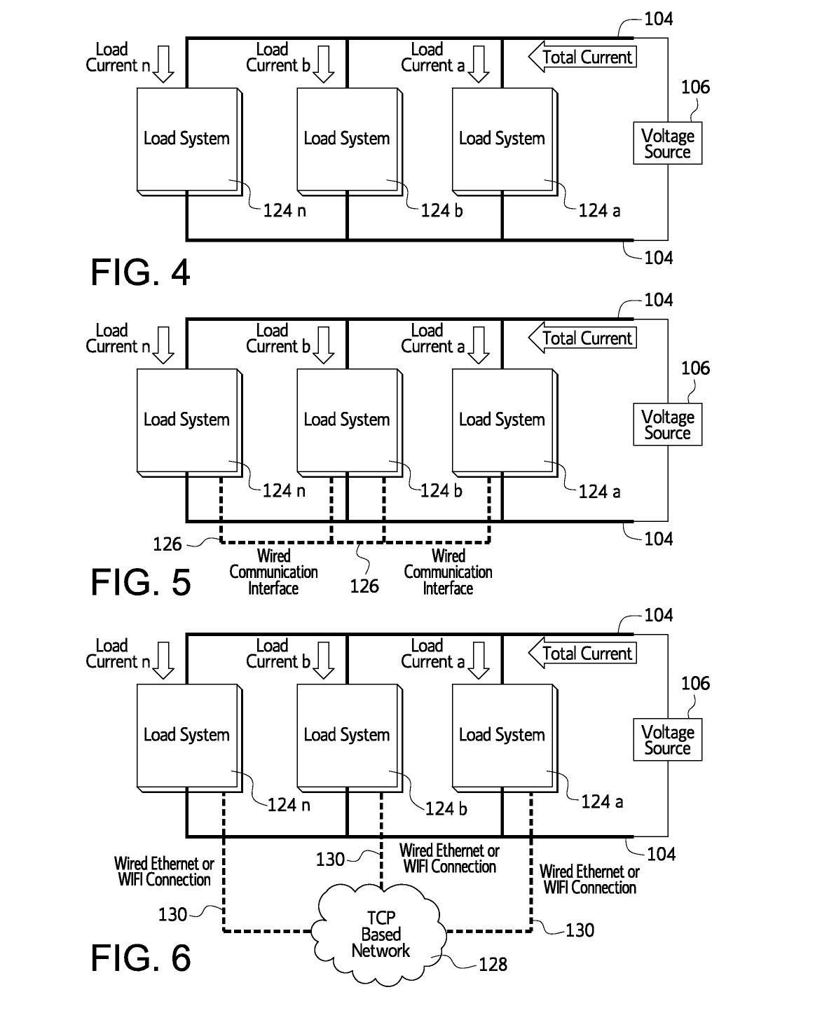

Referring to FIG. 4, there are shown multiple load systems 124a, 124b, 124n connected in parallel to achieve a higher load current via the arithmetic sum of the load currents a, b, . . . n of the individual systems.

In a multiple load system, it is desirable to control multiple load systems simultaneously so that the connected systems operate and respond as a single unit. Connecting the load systems together requires a high degree of electrical interaction between the connected load systems. Each system is provided with a unique address. These systems can communicate status and command messages between each other via standard wired communication interfaces such as RS232 or CANbus devices. Such a multiple load system requires that the load systems be individually hardwired to each other as shown in FIG. 5 where wired connection interfaces 126 are provided between the load systems. (Question—should the wired communication interface be shown as also connecting the systems 124a and 124n as I have shown in FIG. 5?)

Referring to FIG. 6, an improved connection between the load systems according to the invention is shown. This system uses a local communication network 128. Connections to the network can be obtained via a wired or a wireless connection 130. This provides the advantage of automatic system delivery and linkage as well as simplified connection of load systems that are not physically near each other.

As shown in FIG. 3, the load bank system according to the invention preferably includes a computer and network interface 132 which controls the operation of the control module 120 to automatically create a load system combination which provides a selected load current to the source terminals in accordance with the properties of the voltage source. In addition, a manual control and information display device 134 is connected with the control module 120 to manually select a combination of loads to be connected with the source terminals. Thus, instead of automatic selection of load devices being performed by the computer, the system allows an operator to manually select the combination of load devices connected with the source terminals. The display allows the operator to monitor the operation of the load bank and to visualize the various commands and controls communicated between the load devices.

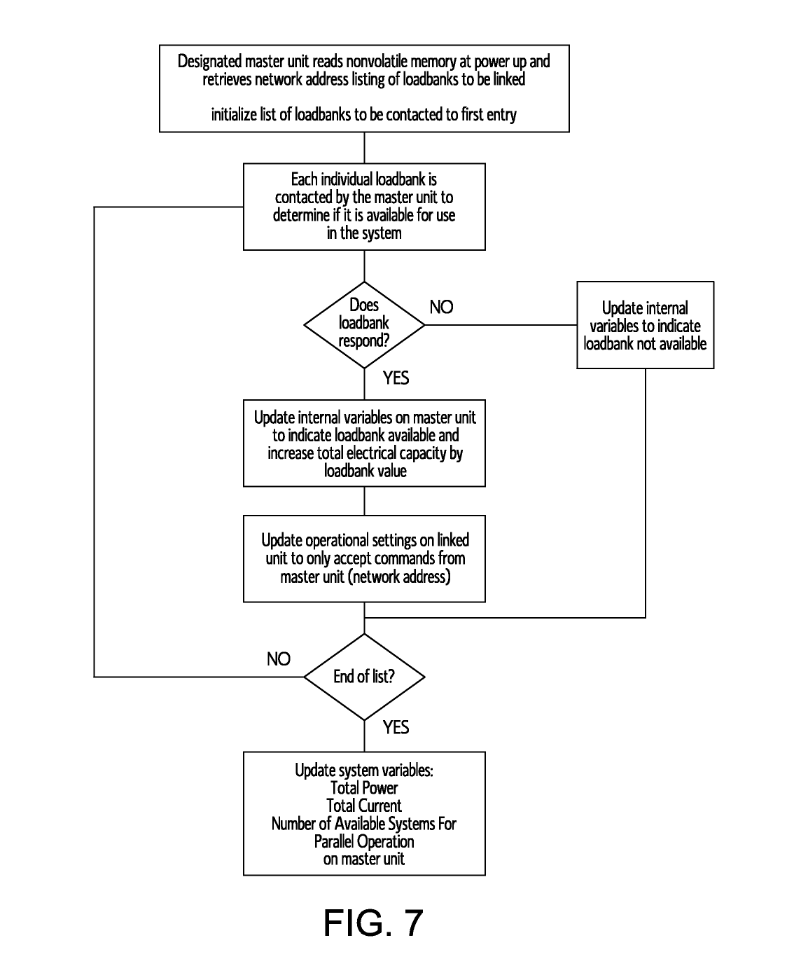

The operation of the virtual load bank system according to the invention will be described with reference to the flow charts of FIGS. 7-10. During installation or at any time thereafter, a discovery operation is performed to establish the virtual parallel load band system. The discovery operation is shown in FIG. 7.

The operator designates one of the load banks connected on the network as the master device or unit. The designation of the master unit is retained in a non-volatile memory within the computer 132 of FIG. 3. The master designation is automatically retrieved upon start up power initiation. The system operator uses the manual control device 134 to manually enter the network addresses of any load bank systems that are to operate in parallel. The list of network addresses is also maintained in non-volatile memory by the designated master unit. Alternatively, the operator may initiate a system discovery operation by the master unit.

During system discovery, the master unit attempts to locate available load banks by sending a network command to every available address on the network. A determination is made as to whether a load bank responds. If a load bank responds and is available, then its network address is added to the list of load bank network addresses maintained in the non-volatile memory by the master unit. This increases the total electrical capacity of the virtual load bank system by the added load bank values. In addition, the operational settings on the available load bank are updated so that it will only accept commands from the master unit. If a load bank does not respond, then the master unit updates the internal variables to indicate that the queried load bank is not available. The discovery sequence of steps is repeated for all network addresses. Once the discovery sequence is complete, the variables for the load bank system are updated to reflect the total power, total current, and number of load units available for parallel operation in the virtual load bank system for the master unit.

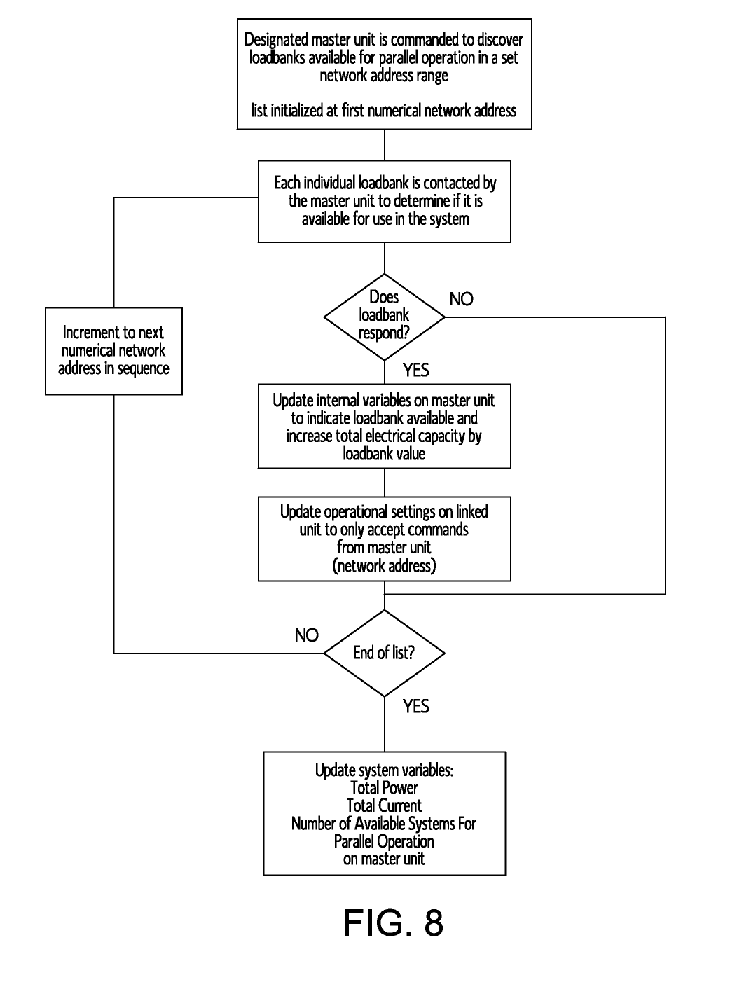

Once the discovery operation is complete and a virtual load bank system is established, the system is ready for start-up operation which is shown in FIG. 8. The designated master unit attempts to contact each load bank in the list of available units, which is retrieved from the non-volatile memory, to determine if the load bank is available for inclusion in the virtual load bank system. If a listed load bank responds, the master unit updates variables for total system power, total system current, and total number of load bank systems. If a load bank does not respond, the master unit attempts to contact the next load bank on the list. The inquiry process is repeated for each of the load banks on the list. Once attempts to contact all of the listed load banks have been completed, the master unit updates all of the variables for the virtual load bank system. The contacted units are placed in parallel operation and will subsequently only accept commands from the designated master unit. The master unit also maintains a listing of network addresses, available power, and available current for each system designated for parallel operation. This information is later used in command distribution by the master unit.

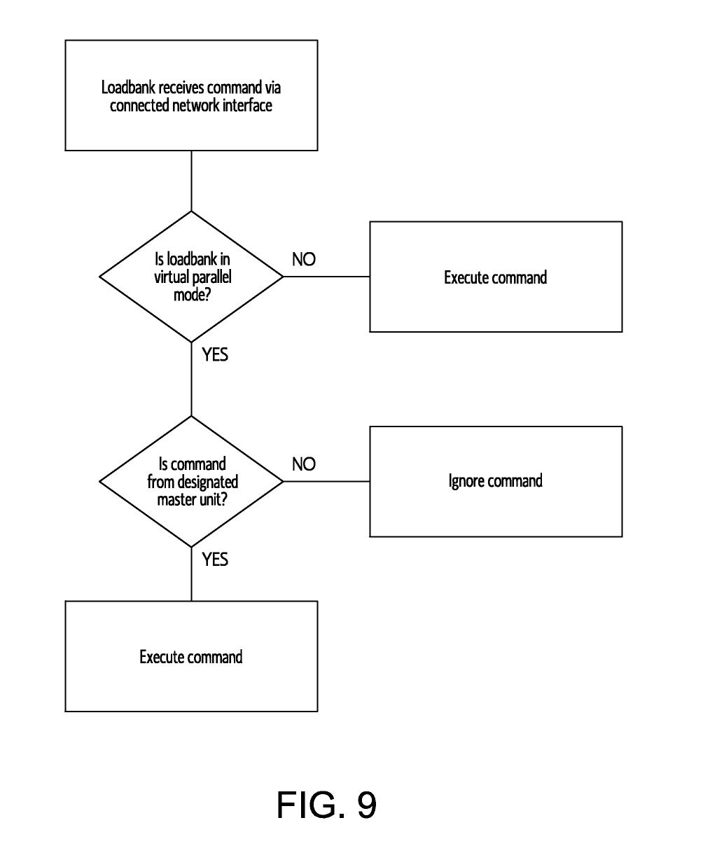

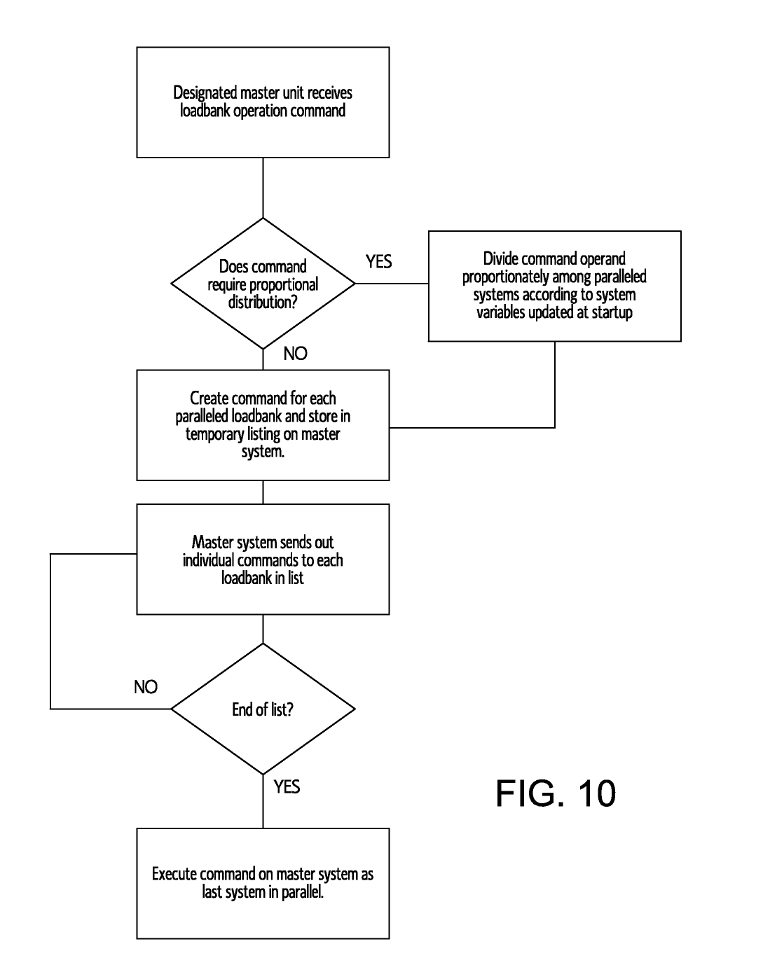

FIG. 9 is a flowchart of command distribution within a linked virtual load bank system and FIG. 10 is a flowchart of master command operation. Once an external command is received by the master unit, it is parsed to obtain both the command to be executed and any operands associated with that command. Commands fall into two categories. The first category includes non-proportional commands that have no operand required for execution. Examples of these commands include LOAD ON and LOAD OFF. The second category of commands includes operands whose values may be proportionally divided between all of the load banks operating in parallel. Examples of these commands include SETKW 1000.

The master unit analyzes each external command. If the command is of the first category, the master unit re-communicates this command to each load bank in the maintained list of parallel load bank systems. Since the load banks in the list have all been designated by the master to operate in parallel and the command originates from the master unit, it is immediately executed by the parallel system.

If the command is of the second category, the master arithmetically divides the operand according to the electrical rating of the individual parallel system and creates and communicates a new command and operand specifically for that system. This is done for each system in the list of parallel units. The master unit also executes a final command based on its own electrical rating.

While the preferred forms and embodiments of the invention have been illustrated and described, it will be apparent to those of ordinary skill in the art that various changes and modifications may be made without deviating from the inventive concepts set forth above.

What is claimed is:

1. A load system for creating a current to be applied to the terminals of a voltage source, comprising
(a) a load bank connected in parallel with the source terminals, said load bank including a plurality of loads;
(b) a controller connected with said load bank for selecting at least one load for connection with the source terminals; and
(c) a communication network connected with each of said loads for communicating status and command information between the loads.

2. A load system as defined in claim 1, wherein said loads each comprise a field effect transistor connected with said controller.

3. A load system as defined in claim 1, wherein said loads comprise one of a fixed inductor, capacitor, and resistor, each having a relay connected in series, said controller being connected with said relays to select which load is connected with said terminals.

4. A load system as defined in claim 1, wherein said communication network comprises a wired or wireless network and said load bank comprises a plurality of loads of different capacities in remote locations, whereby the load bank system can be created by linking selected loads via said communication network to precisely create and control the current supplied to the source terminals.

5. A load system as defined in claim 4, and further comprising a computer connected with said communication network and said controller to automatically create a load system combination which provides a selected load current to the source terminals in accordance with the properties of the voltage source.

6. A load system as defined in claim 5, and further comprising a manual controller connected with said controller to manually select the combination of loads connected with said source terminals.

7. A method for creating a virtual load bank system for creating a current to be applied to the terminals of a voltage source, comprising the steps of
(a) connecting a load bank in parallel with the source terminals, each load bank including a plurality of loads;
(b) designating one of said loads as a master load for connection with the source terminals;
(c) sending an inquiry to other loads in said load bank to determine the availability of other loads for connection with the source terminals; and
(d) connecting at least one of the other loads in parallel with said master load and with the source terminals to precisely create and control the current supplied to the source terminals in accordance with the loads.

8. A method as defined in claim 7, wherein each load has a network address, and further comprising the step of storing the addresses of available loads in a memory.

9. A method as defined in claim 8, and further comprising the steps of manually selecting network addresses for available loads and storing the manually selected addresses in said memory.

10. A method as defined in claim 9, wherein said master load attempts to contact each load in the list of stored network addresses of available loads, and further wherein, for each load that respond to an inquiry, said master load updates variables for total system power, total system current and total number of available loads.

11. A method as defined in claim 10, and further comprising the step of connecting each contacted load in parallel with the system terminals, said connected loads subsequently accepting commands only from said master load.

12. A method as defined in claim 11, and further comprising the step of processing commands received by said master load to control the selection and operation of load devices to create a specific virtual load current for the power source.
